(19) United States
(12) Patent Application Publication
(10) Pub. No.: US 2008/0130882 A1
(43) Pub. Date: Jun. 5, 2008

(54) SECURE PRINTING VIA RFID TAGS

(75) Inventors: Ross E. Hagglund, Hillsboro, OR (US); Cuong M. Le, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/566,764

(22) Filed: Dec. 5, 2006

(51) Int. Cl. H04N 1/44; H04L 9/32; G06K 15/00

(52) U.S. Cl. 380/51; 713/186; 358/1.15; 340/572.1; 358/1.14

(57) ABSTRACT

A printing system adapted for use in a computing infrastructure includes a printer for printing documents; a radiofrequency identification (RFID) reader for communicating with at least one RFID tag and the computing infrastructure; a plurality of RFID tags for authenticating a user; a link for providing communication between an RFID tag and the reader and providing authentication of an RFID tag; and a controller for initiating printing of a document upon the authentication. A method for printing a document includes recognizing a radiofrequency (RFID) tag within a certain proximity of a printer; associating the RFID tag with a document stored in a queue; and printing the document while the RFID tag remains within the certain proximity. A computer program product is provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to document security, and in particular, to secure printing of documents.

2. Description of the Related Art

Increasingly, there is a demand for securing aspects of computing systems. Satisfying the demand calls for, among other things, economic solutions. For example, it many cases it is desirable to have secure printing coupled to a general access network. In such embodiments, the system provides for information security (using known techniques such as encryption, control of privileges, etc, . . . ) while permitting general access. This allows information technology (IT) system managers to avoid massive expenditures in security equipment.

One problem is handling of secure printing in an easy fashion. A commonly used method involves obtaining and entering a PIN at a network printer for printing confidential documents. Unfortunately, this can lead to a “work-around.” For example, consider that some people forget PIN numbers and rely on someone else, or simply print confidential documents in an unsecured fashion.

Some attempts to address network security problems are known. Consider US Patent Application US 20030210424 A1, which appears to describe a system and method for facilitating printing to a local printing device. In one arrangement, the system and method pertain to directly communicating with the local printing device, and obtaining identification information regarding the printing device including a network address of the printing device as a result of the communication with the local printing device so that a print path can be established with the printing device via a network.

Also consider US Patent Application US 20050105734 A1 (Mark Buer, et al) and the corresponding European Patent Application EP 1536306 A1 which appear to describe access to secured services controlled based on the proximity of a wireless token to a computing device through which access to the secured services is obtained. An authorized user may be provided access to a service only when a wireless token assigned to the user is in the proximity of the computing device. A user's credential may be stored on an RFID token and an RFID reader may be implemented within a security boundary on the computing device. Thus, the credential may be passed to the security boundary without passing through the computing device via software messages or applications. The security boundary may be provided, in part, by incorporating the RFID reader onto the same chip as a cryptographic processing component. Once the information is received by the RFID reader it may be encrypted within the chip. As a result, the information may never be presented in the clear outside of the chip. The cryptographic processing component may cryptographically encrypt/sign the credential received from the token so that assurance may be provided to a service provider that the credentials came from a token that was proximate to the computing device. An RFID reader, cryptographic processing components and a wireless network controller may be implemented on a single chip in a mobile device.

In another effort, disclosed in US Patent Application US 20030035539 A1, a system and method for securely distributing secure documents over a network is provided such that an intended recipient can print the secure document data using a home or office desktop printer. The secure document is printed on a specialty paper that includes integral therewith, a first authenticating code. The first authenticating code may be derived from any practical identification technology such as RFID. To generate a secure document, an appropriate detector is integrated into a desktop printing platform. The detector reads the first authenticating code from the specialty paper, which is communicated to a first transaction processor. The first transaction processor provides a second authenticating code and any other secure document data pertinent to the transaction, which is communicated back to the requester of the secure document and printed on the specialty paper.

Unfortunately, the prior art techniques are generally complicated. What are needed are simple techniques that provide for secure printing of documents.

### SUMMARY OF THE INVENTION

The shortcomings of the prior art are overcome and additional advantages are provided through the provision of a printing system adapted for use in a computing infrastructure, the system including: a printer for printing documents; a radiofrequency identification (RFID) reader for communicating with at least one RFID tag and the computing infrastructure; a plurality of RFID tags for authenticating a user; a link for providing communication between an RFID tag and the reader and providing authentication of an RFID tag; and a controller for initiating printing of a document upon the authentication.

Also disclosed is a method for printing a document including: recognizing a radiofrequency (RFID) tag within a configurable proximity of a printer; associating the RFID tag with a document stored in a queue; and printing the document while the RFID tag remains within the certain proximity.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product is provided for printing a document by: coding the document with a security level; requesting the document be stored in a queue until associated with an radiofrequency (RFID) tag; recognizing the RFID tag within a certain proximity of a printer by referencing a source of data including RFID tag information; associating the RFID tag with the document stored in a queue; collecting biometric data and associating the biometric data with the RFID tag; advancing the document in the queue; printing the document while the RFID tag remains within the certain proximity; and initiating security measures when the RFID tag is beyond the certain proximity, wherein the security measures comprise at least one of encryption of a data signal representing the document, interrupting the printing, issuing an alert, issuing an alarm, shredding the document, sending an SMS message and sending an email.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 illustrates aspects of a secure printing system; and

FIG. 3 illustrates an exemplary process for secure printing of documents.

The detailed description explains the preferred embodiments of the invention, together with advantages and features, by way of example with reference to the drawings.

### DETAILED DESCRIPTION OF THE INVENTION

The teachings herein provide for, among other things, use of RFID (Radio Frequency IDentification) tags embedded in an identification badge. An RFID system used in conjunction with an appropriately equipped printer provide for document security for documents printed.

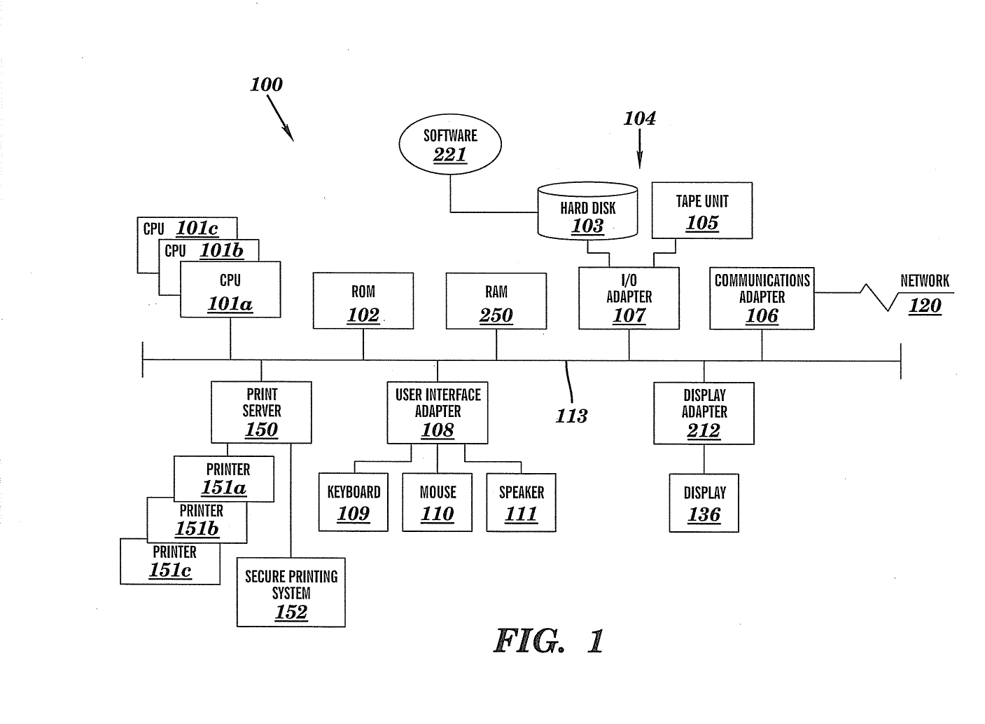

Referring now to FIG. 1, an embodiment of a processing infrastructure 100 for implementing the teachings herein is depicted. Infrastructure 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of infrastructure 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Additional aspects of the infrastructure 100 include a printer server 150 (also referred to as a “controller”) which controls a plurality of printers 151. In typical embodiments, coupled to the printer server 150 is a secure printing system 152. As is known in the art, the printers 151 may include general use printers as well as secure use printers. Typically, the secure printing system 152 makes use of a Radio Frequency Identification (RFID) system as is known in the art. Typically, the printer server 150 provides for, among other things, management of a queue.

As disclosed herein, the infrastructure 100 includes machine readable instructions stored on machine readable media (for example, the hard disk 104) for providing for providing secure printing. As referred to herein, the instructions are referred to as secure printing software 121. The software 121 may be produced using software development tools as are known in the art.

Thus, as configured FIG. 1, the infrastructure 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the infrastructure 100 may make use of any suitable computer, Windows-based terminal, wireless device, information appliance, RISC Power PC, X-device, workstation, mini-computer, mainframe computer, cell phone, personal digital assistant (PDA) or other computing device.

Examples of other operating systems supported by the system 100 include versions of Windows, Macintosh, Java, LINUX, and UNIX, and other suitable operating systems.

Users of the infrastructure 100 may connect to the network 120 through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

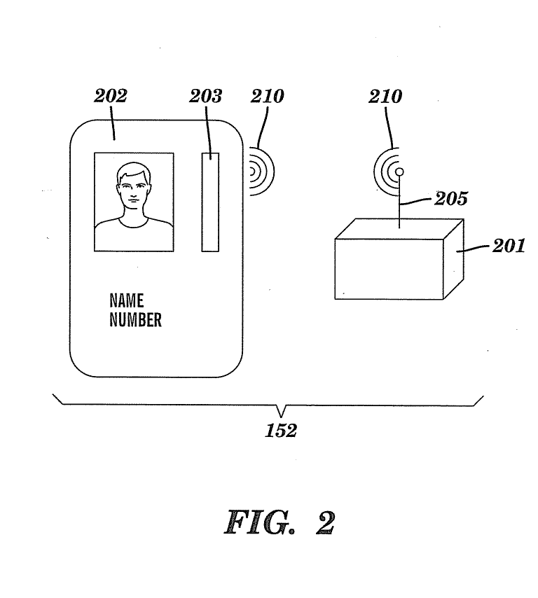

Referring now to FIG. 2, embodiments of the secure printing system 152 include a RFID reader 201 and a plurality of identification badges 202. Each badge 202 includes an RFID tag 203, as is known in the art. Also as is known in the art, the RFID reader 201 provides and receives a wireless signal 210. The wireless signal 210 includes communication of authentication information for secure printing. Typically, an antenna 205 for the RFID reader 201 is associated with each secure use printer 151. The antenna 205 may be located some distance away from a base station for the reader 201 of the secure printing system 152.

In practice, each badge 202 is associated with a user (such as an employee). When the user (i.e., the badge 202) is within a certain proximity of the secure use printer 151, the RFID system 152 recognizes the badge 202 and authenticates the user. Typically, the certain proximity includes a distance that may be configured by, for example, an administrator. Recognition and authentication occurs using various authentication schemes as are known in the art, and may include software, data tables, communications protocols, encryption and other such technologies (not shown).

Typically, the secure printing system 152 is a portion of an otherwise general use infrastructure 100. A variety of embodiments may be provided for to provide secure printing by use of the infrastructure 100. For example, when printing a document from a workstation, a user may select a “secure printing” option from a dialog box. Selecting the secure printing option provides for a certain sequence of security steps to be invoked.

As an example, the security steps associate the user identification information with the user RFID tag 203 of record. The secure printing system 152 sends the document to a secure printer 151. In one embodiment, the document is sent over the network 120 in an encrypted form. When the document reaches a designated printer 151, the secure printing system 152 holds the document in the queue until authentication occurs. The authentication is provided when the user (with the badge 202) approaches the secure printer 151 and an exchange of RFID based information is successfully provided. In simple terms, when the user is within a range to control the printout, the document begins printing.

In some embodiments, the secure printing system 152 holds all documents for secure printing in a queue. When a user is within range of the selected printer 151, all documents for the user are advanced and commence printing. Accordingly, the secure printing system 152 typically includes instructions for queue management.

In some other embodiments, the secure printing system 152 does not include security measures. That is, aspects of encryption and such are not relied upon. Some of these embodiments make particular use of the queue management features. For example, it is known that in many group use printing environments that documents are often lost, incorrectly picked up by someone else, or sent to the printer 151 and then neglected. This results in an enormous waste of resources, and typically some degree of confusion at the printer 151.

Accordingly, in some embodiments, the secure printing system 152 is designed around efficient document management. That is, in some embodiments, documents (including those that do not require security measures) only commence printing when the user is within the certain proximity of the printer 151.

In some embodiments, the secure printing system 152 terminates ongoing printing when required. For example, when the user exits from the proximity of the printer 151, the secure printing system 152 assumes that security is, at least momentarily, breached. Accordingly, the secure printing system 152 may do any one or more of a number of things. For example, the secure printing system 152 may terminate the ongoing print job, may direct the remaining portion to a shredder and may alert the user by actuation of some sort of alarm (audio, visual, SMS to a pager, etc, . . . ).

In further embodiments, the secure printing system 152 includes provisions for automatic recognition of confidential documents. For example, any record having employee information, trade secrets, and other such information. In some of these embodiments, the secure printing system 152 sends the information to the printer 151 with a requirement for use of the security features. That is, in some instances use of the secure printing features is not optional. In typical embodiments where this is the case, documents may be coded with a security level, and the infrastructure 100 includes an index, cross reference or other form of reference to manage security accordingly.

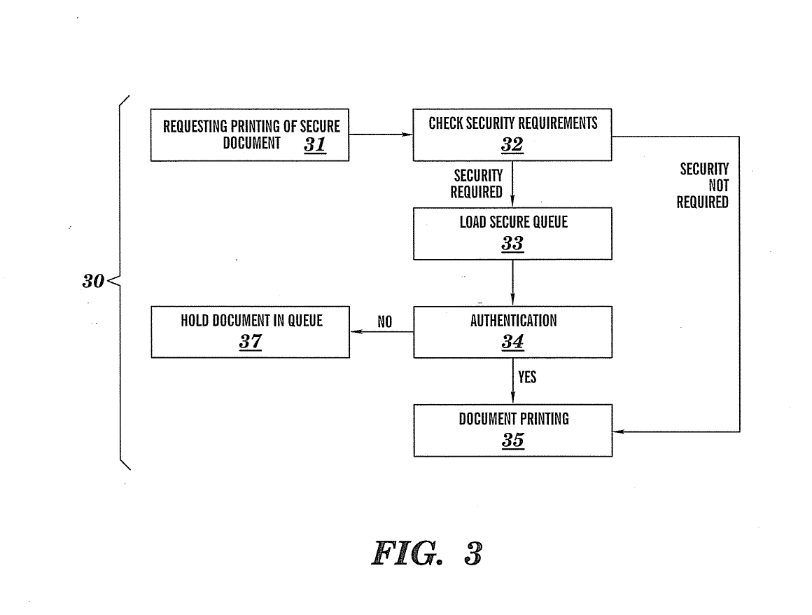

FIG. 3 provides an exemplary flow diagram for printing secure documents. In the exemplary method for printing secure documents 30, a user requests printing of secure document 31. The system then checks a security requirement for the document 32. If security is required, the system loads a secure printing queue 33 with the secure document. The user then takes the badge 202 to the secure printer 151. When the user's badge 202 is within a proximity to the secure printer, authentication is completed 34. Once authentication is completed 34, printing 35 of the document commences. Typically, the method for printing secure documents 30 calls for holding documents in a queue 37 if authentication is not realized.

In various embodiments, the RFID system is only a part of the secure printing system 152. For example, in additional embodiments, the secure printing system 152 includes biometric features (such as to protect against lost or stolen badges).

In some embodiments, a Queue Management System is provided. The Queue Management System operates on the queue. Exemplary queue management provides for cancellation of print requests, deletion of print requests, such as where print requests have not been printed within a configured time period and others.

In some embodiments, an individual can send something to a printer securely on behalf of someone else. For example, a first person at a first location may send confidential documents to at least a second person at a second location. In these embodiments, the first person identifies, at least, the recipient (second person). The system 100 then makes associations such as, for example, the RFID tag 203 and the printer 151 for the second person. Printing of the documents commences as otherwise provided for herein.

Accordingly, aspects of the secure printing system 152 may be referred to as being “security measures.” Security features include, for example, encryption of a data signal representing a document to be printed using security protocols, print interruption (such as when the user leaves the proximity of the printer), alerts, alarms, SMS messaging, an email (such as to a system security administrator), shredding of documents and other aspects as well.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A printing system adapted for use in a computing infrastructure, the system comprising:
a printer for printing documents;
a radiofrequency identification (RFID) reader for communicating with at least one RFID tag and the computing infrastructure;
a plurality of RFID tags for authenticating a user;
a link for providing communication between an RFID tag and the reader and providing authentication of an RFID tag; and
a controller for initiating printing of a document upon the authentication.

2. The system as in claim 1, wherein the link is established when the user is within a range to control the document.

3. The system as in claim 1, further comprising a computer program product stored on machine readable media, the product providing instructions for selecting document security measures.

4. The system as in claim 1, wherein the document security measures comprise at least one of encryption of a data signal representing the document, print interruption, an alert, an alarm, a shredding command, an SMS message and an email.

5. The system as in claim 1, wherein the RFID tag is included within an employee badge.

6. A method for printing a document comprising:
recognizing a radiofrequency (RFID) tag within a configurable proximity of a printer;
associating the RFID tag with a document stored in a queue; and
printing the document while the RFID tag remains within the certain proximity.

7. The method as in claim 6, wherein the recognizing comprises referencing a source of data comprising RFID tag information.

8. The method as in claim 6, further comprising requesting the document be stored in the queue until associated with the RFID tag.

9. The method as in claim 6, further comprising coding the document with a security level.

10. The method as in claim 6, further comprising collecting biometric data before the printing.

11. The method as in claim 10, further comprising associating the biometric data with the RFID tag.

12. The method as in claim 6, further comprising initiating security measures when the RFID tag is beyond the certain proximity.

13. The method as in claim 10, wherein the security measures comprise at least one of encryption of a data signal representing the document, interrupting the printing, issuing an alert, issuing an alarm, shredding the document, sending an SMS message and sending an email.

14. The method as in claim 6, wherein printing comprises advancing the document in the queue.

15. The method as in claim 6, wherein a first person provides the document, and at least a second person is associated with the RFID tag.

16. The method as in claim 6, wherein a first person loads the document at a first location and the printing occurs at another location.

17. A computer program product stored on machine readable media, the product comprising instructions for printing a document, by:
coding the document with a security level;
requesting the document be stored in a queue until associated with an radiofrequency (RFID) tag;
recognizing the RFID tag within a configurable proximity of a printer by referencing a source of data comprising RFID tag information;
associating the RFID tag with the document stored in a queue;
collecting biometric data and associating the biometric data with the RFID tag;
advancing the document in the queue;
printing the document while the RFID tag remains within the certain proximity; and
initiating security measures when the RFID tag is beyond the certain proximity, wherein the security measures comprise at least one of encryption of a data signal representing the document, interrupting the printing, issuing an alert, issuing an alarm, shredding the document, sending an SMS message and sending an email.
